(19) United States
(12) Patent Application Publication
(10) Pub. No.: US 2014/0295217 A1
(43) Pub. Date: Oct. 2, 2014

(54) Miniaturized Forklift Fuel Cell Supply System

(71) Applicant: INFINTIUM FUEL CELL SYSTEMS (SHANGHAI) CO., LTD., Shanghai (CN)

(72) Inventor: Xuxu Ge, Shanghai (CN)

(21) Appl. No.: 14/306,258

(22) Filed: Jun. 17, 2014

Related U.S. Application Data
(63) Continuation of application No. PCT/CN2013/083379, filed on Sep. 12, 2013.

(30) Foreign Application Priority Data
Sep. 28, 2012 (CN) 201210376327

(51) Int. Cl. H01M 8/04; H01M 16/00

(52) U.S. Cl. CPC H01M 8/04895; H01M 16/006
USPC 429/9

(57) ABSTRACT

This invention provides a kind of miniaturized forklift fuel cell supply system consists of enclosure 90 and the fuel cell system 100 provided in the said enclosure 90, DCDC converting unit 2, contactor 3, energy storage device 4, controller 7, which also consists of the power supply output end 5 provided outside the said enclosure 90 and the operation control unit 6 provided in the said enclosure 90, in which, the said contactor 3 is a normal open type high-current contactor, the said DCDC converting unit 2 includes the DCDC converter 21 and high-power diode 22 connecting with it. This invention is compact in structure and facilitates such work as system installation, overhaul and maintenance, etc. This invention can contain an energy storage device with a higher capacity, making the energy storage device be in a charging and discharging condition with a low multiplying factor and extending the service life of the energy storage device and the time for which the system can be left unused.

### PRIORITY

The present invention claims priority to PCT patent application PCT/CN2013/083379, which has a filing date of Sep. 12, 2013. The present invention claims priority to Chinese patent application 201210376327, which has a filing date of Sep. 28, 2012.

### FIELD OF THE INVENTION

This invention relates to the new energy field, specifically to miniaturized fuel cell supply system.

### BACKGROUND

At present, a lot of electric vehicles exists, for example, electric forklift, electric tourist coach, etc. All these electric vehicles use lead-acid battery as the source of electric energy. In relation to internal combustion engine, the lead-acid battery has no noise, exhaust gas and is much cleaner and more environmentally friendly. However, the lead-acid battery has a lot of problems in production, use.

In use, with the capacity of lead-acid battery reducing, the forklift power performance reduces, which is embodied by lower forklift speed, being unable to lift up a load. The working efficient is seriously influenced. The lead-acid battery needs 6˜8 hours for charging after use and it takes 20 minutes for changing batteries. A logistic center with three shifts has to use three lead-acid batteries to supply power for one electric forklift. As the usable capacity reduces constantly, a lead-acid battery can only be used for 2˜3 years. A forklift working for three shifts has to change 3 groups of batteries.

Lead-acid battery can generate acid mist in use, even in the food in a logistic center, lead can be detected. As lead-acid battery has a lot of pollution in production, a lot of countries and regions have gradually limited the production and manufacturing of lead-acid batteries. This has led to the price of lead-acid battery rising to a certain degree.

Each year, a lot of electric forklifts are sold, leading to a lot of lead-acid batteries needing replacement. Therefore, a kind of new power supply is needed urgently for replacement. The existing technology provides multiple schemes, but the existing technology has a lot of disadvantages. Some design reduces system function; some design adopts an energy storage device with a small size and a small capacity, resulting in reduction in system performance; some design even has the hydrogen bottle be placed outside the system; some design provides almost no space for moving between parts and components in the system, as a result, when disassembling a part and component, other parts and components have to be removed; some design has no space in the system for the emergency stop button and relies on the emergency stop button designed for the hydrogen filling system, this may result in being unable to close the system quickly under an exceptional system emergency condition.

The technical scheme publicized by the utility model patent of China called “forklift gas bottle fixing device” with application number “200820233706.2” has the gas bottle be placed at the back end of a forklift, when using, it is necessary to change the hydrogen bottle, this also needs a lot of time. At the same time, placing a gas bottle at back of a forklift is very unsafe. Due to the system being not compact, that scheme is unable to place the hydrogen bottle inside the system.

The Canadian patent called “FUEL CELL INDUSTRIAL VEHICLE” with publication number “CA2659135A1” provides a fuel cell forklift system scheme and redesigns the whole forklift. No direct replacement of the existing forklift cell can be made.

The utility model patent of China called “a new type of forklift” with application number “200920174236.1” provides a technical scheme which also considers redesign of existing vehicle.

The utility model patent of China called “a type of fuel cell forklift” with application number “200820179687.X” provides a technical scheme which also considers forklift redesign.

### SUMMARY

Aimed at the defects in existing technology, the said miniaturized forklift fuel cell supply system solves the compact problem with the forklift fuel cell system. The forklift fuel cell has the whole system be placed in a rectangular empty chamber. Due to dimensional limitation, there is almost no space for moving between the parts and components. The line installation is troublesome. Disassembly of parts and components are troublesome with other parts and components having to be removed first. A space for weights is reserved.

The said miniaturized forklift fuel cell supply system consists of enclosure and the fuel cell system provided in the said enclosure, DCDC converting unit, contactor, energy storage device, controller, which also consists of the power supply output end provided outside the said enclosure and the operation control unit provided in the said enclosure, in which, the said contactor 3 is a normal open type high-current contactor, the said DCDC converting unit includes the DCDC converter and high-power diode connecting with it.

The said fuel cell system connects the said DCDC converting unit, contactor, power supply output end, the said controller connects the said fuel cell system, operation control unit, contactor, the said energy storage device connects the said controller, operation control unit and contactor.

The said fuel cell system, energy storage device are provided in proper order on the electric isolation board of the said enclosure along the said enclosure in a direction from front to back, the said DCDC converting unit is located right above the said energy storage device, the said operation control unit and controller are located right above the said DCDC converting unit.

Preferably, the said controller and operation control unit are installed in proper order along the said enclosure in a direction from front to back.

Preferably, the said contactor is installed in the space between the side board of the said enclosure and the said operation control unit.

Preferably, the hydrogen storage system, the filling valve provided in the said enclosure are also included, the said electric isolation board divides the space of the said enclosure into an electronic system space and a gas supply space, the said fuel cell system, DCDC converting unit, contactor, energy storage device, controller, operation control unit, filling valve are located in the said electronic system space, the said hydrogen storage system is located in the said gas supply space, the said gas supply space is located at the lower part of the said electronic system space.

Preferably, the output end of the fuel cell 1 that the said fuel cell system contains connects the input end of the said DCDC converting unit, the DCDC converting unit connects through the said contactor the said energy storage device, the output end of the said DCDC converting unit also connects the said power supply output end and the high-power auxiliary component that the said fuel cell system contains, the port of the said energy storage device connects through the said contactor the said power supply output end and the high-power auxiliary component that the said fuel cell system contains, the said operation control unit connects respectively the said energy storage device, DCDC converting unit, controller, the said controller connects respectively the fuel cell that the said fuel cell system contains, auxiliary system, DCDC converting unit, the control end of contactor, energy storage device, in which, the said auxiliary system 8 includes the said high-power auxiliary component.

The said operation control unit is used to receive operation signals and supplies power for the said controller and DCDC converting unit, the said controller is used to receive the operation instructions generated by the said operation control unit according to the said operation signals and controls according to the said operation instructions the said contactor, DCDC converting unit, auxiliary system, the said controller is also used to measure the state parameters of the fuel cell that the said fuel cell system contains, measure the state parameters of the said energy storage device, measures the state parameters of the said auxiliary system and receives the state data of the said DCDC converting unit.

Preferably, the output end of the said fuel cell connects the input end of the said DCDC converter, the positive pole of the output end of the said DCDC converter connects the positive pole of the said high-power diode, the negative pole of the said high-power diode connects through the said contactor the said energy storage device, the said DCDC converter connects the said controller and is controlled by the said controller, the said DCDC converter connects the said operation control unit and receives the power supplied by the said operation control unit.

Preferably, the said operation control unit changes the electric connection state with the said DCDC converting unit and controller according to the startup operation signal received.

Preferably, the state data of the said DCDC converting unit include DCDC input current, DCDC input voltage.

Preferably, any one or more following devices are also included:
The hydrogen safety system, the said hydrogen safety system includes the sensors placed respectively in the electronic control system space and gas supply space, the said sensors connect the said controller,
The monitoring display, the said monitoring display connects the said controller,
The ON and OFF button, the said ON and OFF button connects respectively the said operation control unit and controller,
The remote control, the said remote control connects in a radio mode the said operation control unit,
The emergency stop button, the said emergency stop button connects the said operation control unit.

Comparing with the existing technology, the said miniaturized forklift fuel cell supply system has the following beneficial effects:

1) The energy storage device placed by the existing technology in the system is small in capacity, making the energy storage device be in a charging and discharging condition with a high multiplying factor and reducing the service life of the energy storage device. The said miniaturized forklift fuel cell supply system can contain an energy storage device with a higher capacity, making the energy storage device be in a charging and discharging condition with a low multiplying factor and extending the service life of the energy storage device and the time for which the system can be left unused. For example, in the circumstance that what is placed in the energy storage device is a lithium ion battery, the lithium ion battery placed as designed by the existing technology has a capacity 32 AH, a peak output 10 KW. The lithium ion battery that can be placed in the said miniaturized forklift fuel cell supply system has a capacity 50 AH, a peak output 15 KW. When absorbing the forklift braking at 600 A, the charging multiplying factor is 12 C. That value in the existing technology is 18 C. A higher energy storage device capacity reduces the charging and discharging multiplying factor at the same current output and favors extension of battery service life.

2) The said miniaturized forklift fuel cell supply system is compact in structure and facilitates such work as system installation, overhaul and maintenance, etc.

3) In the enclosure, the operation control unit, controller are placed on the top. In the circumstance when they are not used by the system and moved outside forklift, inspection and maintenance, failure recovery can be made. The controller control software upgrading is also facilitated.

4) Spaces are reserved between parts and components, parts and components and enclosure, which facilitates line connection, part and component removal.

5) The compact structural design of the said miniaturized forklift fuel cell supply system allows placing of the emergency stop button. In case of any emergency, the whole system can be disconnected quickly.

6) Such components as ON and OFF button, emergency stop button, filling valve, etc. required by system operation are placed at appropriate heights to facilitate filling, operation.

### BRIEF DESCRIPTION OF THE DRAWINGS

By reading and referring to the detailed descriptions made to the non-restrictive embodiment examples by the following attached figures, other characteristics, purposes and advantages of this invention will become more evident:

FIG. 1 is the schematic diagram of the general structure of miniaturized forklift fuel cell supply system;

FIG. 2 is the schematic diagram of the structure of the miniaturized fuel cell supply system according to this invention;

FIG. 3 is the specific structural schematic diagram of the DCDC converting unit in the miniaturized fuel cell supply system as shown in FIG. 2;

FIG. 4 shows the schematic diagram of the high-power diode position in the miniaturized fuel cell supply system of a preferable case of the first embodiment example provided according to this invention;

FIG. 5 is embodiment A of the miniaturized forklift fuel cell supply system;

FIG. 6 is embodiment B of the miniaturized forklift fuel cell supply system.

### DETAILED DESCRIPTION

A detailed description to this invention is to be made below by combining with specific embodiment examples. The following embodiment examples will help the technical personnel in this field further understand this invention, but it does not limit this invention in any form. It should be pointed out that for ordinary technical people in this field, adjustments and changes can also be made under the prerequisite of not being divorced from the conceiving of this invention. All these belong to the protection scope of this invention.

The said miniaturized forklift fuel cell supply system consists of enclosure 90 and the fuel cell system 100 provided in the said enclosure 90, DCDC converting unit 2, contactor 3, energy storage device 4, controller 7, which also includes the power supply output end 5 provided outside the said enclosure 90 and the operation control unit 6 provided in the said enclosure 90, in which, the said contactor 3 is a normal open type high-current contactor, the said DCDC converting unit 2 includes the DCDC converter 21 and high-power diode 22 connecting with it,

The said fuel cell system 100 connects the said DCDC converting unit 2, contactor 3, power supply output end 5, the said controller 7 connects the said fuel cell system 100, operation control unit 6, contactor 3, the said energy storage device 4 connects the said controller 7, operation control unit 6 and contactor 3,

The said fuel cell system 100, energy storage device 4 are provided in proper order on the electric isolation board 901 of the said enclosure 90 along the said enclosure 90 in a direction from front to back, the said DCDC converting unit 2 is located right above the said energy storage device 4, the said operation control unit 6 and controller 7 are located right above the said DCDC converting unit 2. The said controller 7 and operation control unit 6 are installed in proper order along the said enclosure 90 in a direction from front to back. The said contactor 3 is installed in the area between the side board of the said enclosure 90 and the said operation control unit 6.

In a preferable case, the said miniaturized forklift fuel cell supply system also consists of the hydrogen storage system, filling valve 95 provided in the said enclosure 90, the said electric isolation board 901 divides the space of the said enclosure 90 into an electronic system space and a gas supply space, the said fuel cell system 100, DCDC converting unit 2, contactor 3, energy storage device 4, controller 7, operation control unit 6, filling valve 95 are located in the said electronic system space, the said hydrogen storage system is located in the said gas supply space, the said gas supply space is located at the lower part of the said electronic system space.

The said fuel cell system 100 consists of fuel cell 1 and auxiliary system 8. The said auxiliary system 8 consists of air supply system, cooling system, hydrogen system, the said high-power auxiliary component 80 refers to a high-power component in the auxiliary system (for example fan, pump, heat dissipation fan). The technical people in this field can refer to the existing technology to accomplish the said auxiliary system 8 and its high-power auxiliary component 80. No unnecessary detail is to be given here.

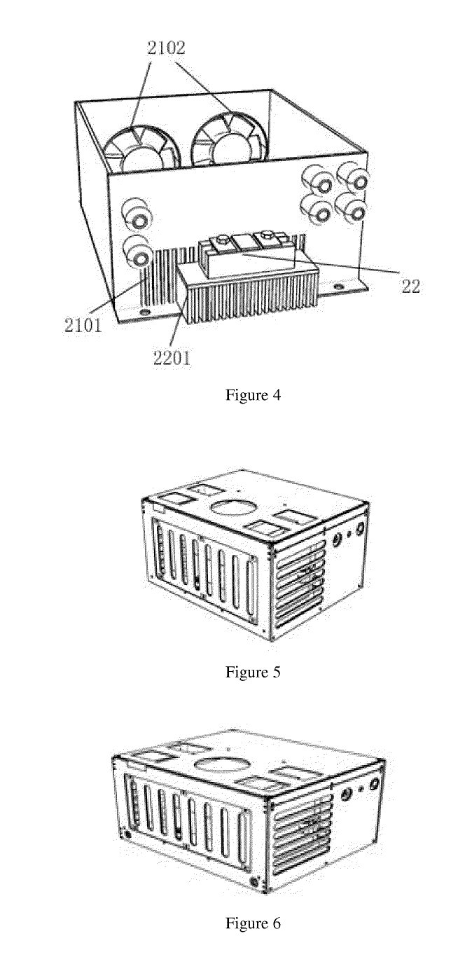

FIG. 5 and FIG. 6 show the fuel cell supply systems in the two embodiments of the said miniaturized forklift fuel cell supply system. Specifically, FIG. 21 shows embodiment C-1: an electric piling forklift from a forklift plant uses 24V lead-acid battery voltage. That lead-acid battery is 920 mm long, 361 mm wide, 787 mm high, weighs 702 kg with a voltage 24V. The working voltage range of the forklift is 20-30V. The system is designed to be 920 mm long, 360 mm wide, 786 mm high, weigh 702 Kg with a rated system voltage 20-30V. FIG. 22 shows embodiment C-2: a standing-steer type pallet-carrying forklift from a forklift plant uses 24V lead-acid battery, which is 790 mm long, 330 mm wide, 784 mm high and weighs 300 kg. The working voltage range of the forklift is 20-30V. The system is designed to be 780 mm long, 325 mm wide, 780 mm high, weigh 300 Kg with a rated system voltage 20-30V.

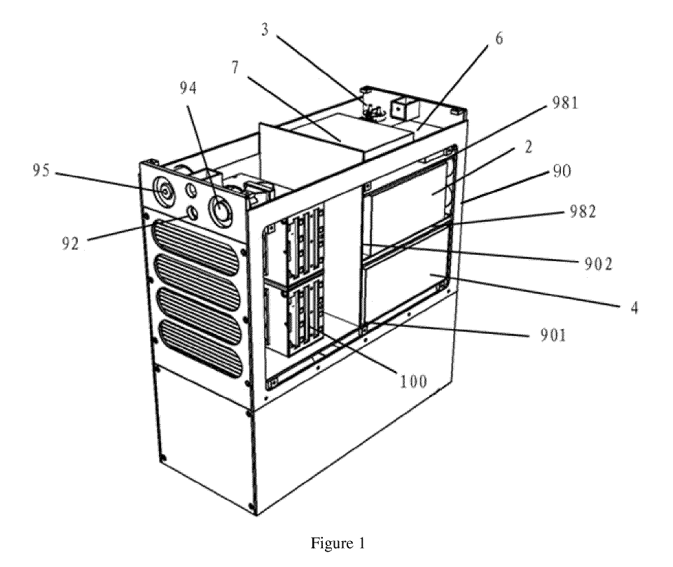

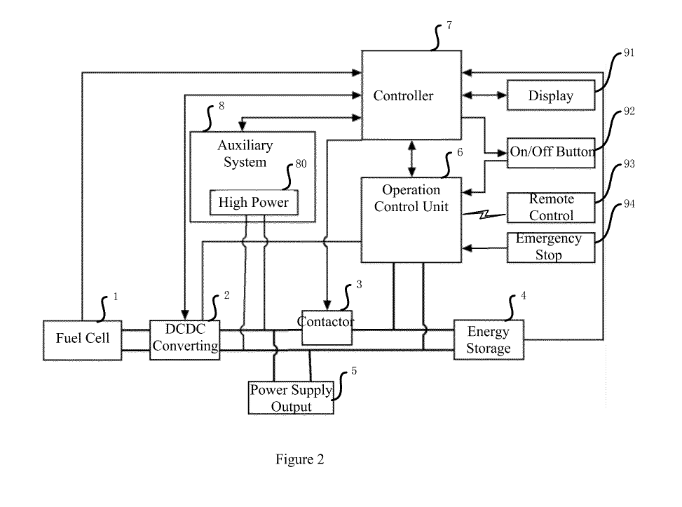

The reason that a compact structure as shown in FIG. 1 can be designed for the said forklift fuel cell supply system is mainly due to adopting the compact type fuel cell supply system as shown in FIG. 2.

FIG. 2 is the schematic diagram of the structure of the compact type fuel cell supply system of the first embodiment example provided according to this invention, in this embodiment example, the said compact type fuel cell supply system consists of fuel cell 1, DCDC converting unit 2, contactor 3, energy storage device 4, power supply output end 5, operation control unit 6, controller 7, auxiliary system 8, in which the said contactor 3 is a normal open type high-current contactor, the said DCDC converting unit 2 includes DCDC converter 21 and high-power diode 22 connecting with it.

Specifically, the output end of the said fuel cell 1 connects the input end of the said DCDC converting unit 2, DCDC converting unit 2 connects through the said contactor 3 the said energy storage device 4, the output end of the said DCDC converting unit 2 also connects the said power supply output end 5 and the high-power auxiliary component 80 that the said auxiliary system 8 contains, the port of the said energy storage device 4 connects through the said contactor 3 the said power supply output end 5 and auxiliary system 8, the said operation control unit 6 connects respectively the said energy storage device 4, DCDC converting unit 2, controller 7, the said controller 7 connects respectively the said fuel cell 1, DCDC converting unit 2, the control end of contactor 3, energy storage device 4 and auxiliary system 8.

In this embodiment example, the positive pole of the output end of the said DCDC converting unit 2 connects through the said contactor 3 the positive pole of the said energy storage device 4, the negative pole of the output end of the said DCDC converting unit 2 connects through the said contactor 3 the negative pole of the said energy storage device 4, the positive pole of the said energy storage device 4 connects through the said contactor 3 the positive pole of the said power supply output end 5 and the positive pole of auxiliary system 8, the negative pole of the said energy storage device 4 connects directly the negative pole of the said power supply output end 5 and the negative pole of auxiliary system 8; and in a variation of this embodiment example, the difference from the first embodiment example as shown in FIG. 1 is that in this variation, the change of the said contactor 3 in connecting position is: the said contactor 3 is connected between the negative pole of the output end of the said DCDC converting unit 2 and the negative pole of the said energy storage device 4, and the positive pole of the output end of the said DCDC converting unit 2 and the positive pole of the said energy storage device 4 are connected directly between them, correspondingly, the positive pole of the said energy storage device 4 connects directly the positive pole of the said power supply output end 5 and the positive pole of auxiliary system 8, the negative pole of the said energy storage device 4 connects through the said contactor 3 the negative pole of the said power supply output end 5 and the negative pole of auxiliary system 8. The technical people in this field understand that the two connection modes for contactor 3 as described in this natural paragraph can both realize “DCDC converting unit 2 connecting through the said contactor 3 the said energy storage device 4” and “the port of the said energy storage device 4 connecting through the said contactor 3 the said power supply output end 5 and auxiliary system 8”.

The said auxiliary system 8 consists of air supply system, cooling system, hydrogen system, hydrogen safety system, the said high-power auxiliary component 80 refers to a high-power component in the auxiliary system (for example, fan, pump, heat dissipation fan). The technical people in this field can refer to the existing technology to accomplish the said auxiliary system 8 and its high-power auxiliary component 80. No unnecessary detail is to be given here.

The said operation control unit 6 is used to receive operation signals and supplies power for the said controller 7 and DCDC converting unit 2, the said controller 7 is used to receive the operation instructions generated by the said operation control unit 6 according to the said operation signals and control according to the said operation instructions the said contactor 3, DCDC converting unit 2, auxiliary system 8, the said controller 7 is also used to measure the state parameters of the said fuel cell 1, measure the state parameters of the said energy storage device 4, measure the state parameters of the said auxiliary system 8 and receive the state data of the said DCDC converting unit 2. The said DCDC converter 21 consists of CAN communication module, input voltage measurement module, input current measurement module, output voltage measurement module, output current measurement module. Preferably, DCDC converter 21 can control according to the communication data of the CAN communication module the specific numerical values of the output current, voltage; also outputs through the CAN communication module such data as input voltage, input current, output voltage, output current, etc. The state data of the said DCDC converting unit 2 includes DCDC input current, DCDC input voltage.

The said controller 7 is a controller with an integrated design, which is equivalent to the scattered fuel cell controller, whole vehicle controller, battery energy management system in the invention patent application of China with patent application number “200610011555.1”; further specifically, the said controller 7 can consist of energy management unit, fuel cell control unit, energy storage device monitoring unit, hydrogen safety monitoring unit, system failure monitoring unit and startup control unit.

More specifically, as shown in FIG. 2, the output end of the said fuel cell 1 connects the input end of the said DCDC converter 21, the positive pole of the output end of the said DCDC converter 21 connects the positive pole of the said high-power diode 22, negative pole of the said high-power diode 22 connects through the said contactor 3 the said energy storage device 4, the said DCDC converter 21 connects the said controller 7 and is controlled by the said controller 7, the said DCDC converter 21 connects the said operation control unit 6 and receives the power supplied by the said operation control unit 6. And in a variation of this embodiment example, the difference from the first embodiment example as shown in FIG. 2 is that in this variation, the positive pole of the output end of the said fuel cell 1 connects the positive pole of the said high-power diode 22, the negative pole of the said high-power diode 22 connects the positive pole of the input end of the said DCDC converter 21, the negative pole of the output end of the said fuel cell 1 connects directly the negative pole of the input end of the said DCDC converter 21, the output end of the said DCDC converter 21 directly connects through the said contactor 3 the said energy storage device 4.

Further, in this embodiment example, the said compact type fuel cell supply system also consists of monitoring display 91, ON and OFF button 92, remote control 93, emergency stop button 94, in which the said monitoring display 91 connects the said controller 7, the said ON and OFF button 92 connects respectively the said operation control unit 6 and controller 7, the said remote control 93 connects in a radio mode the said operation control unit 6, the said emergency stop button 94 connects the said operation control unit 6. As shown in FIG. 1, when the said ON and OFF button 92 or remote control 93 gives a startup signal, the said operation control unit 6 supplies power to the said controller 7, the said controller 7 outputs a control signal to the contactor used as a switch to make it close, the said energy storage device 4 supplies power through the said contactor 3 to the said high-power auxiliary component 80, in the said auxiliary system 8, except the said high-power auxiliary component 80, other devices (for example, hydrogen system, hydrogen safety system) are supplied by the said controller 7, at the same time, the said controller 7 outputs signals to all modules constituting the said auxiliary system 8 to start the said fuel cell 1; after starting, the said contactor 3 maintains the state of connection at all times. By adopting this starting mode, it is not necessary to use additionally configured auxiliary battery and auxiliary DC/DC converter for charging, as a result, parts and components and corresponding lines are reduced, system reliability is improved, space is saved, system volume and costs are reduced.

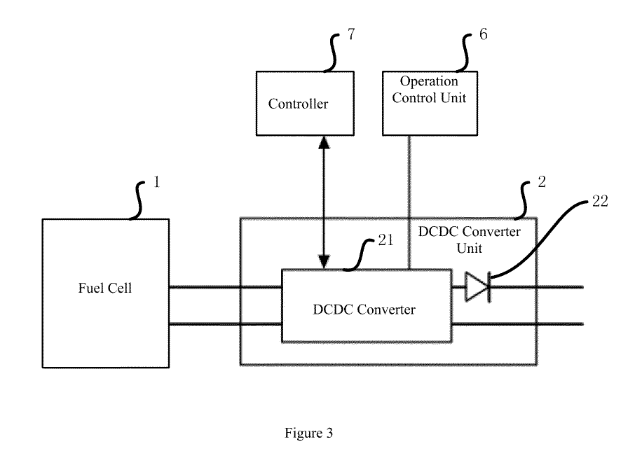

In a preferable case of this embodiment example, as shown in FIG. 3, the said high-power diode 22 is placed on the heat dissipation passage of the said DCDC converter 21, this can use the air discharged from the air duct 2101 by the heat dissipation fan 2102 contained by the said DCDC converter itself to dissipate heat from the said high-power diode 22, as a result, the heat dissipation fan on the heat dissipater 2201 (i.e. aluminum fin) for the said high-power diode is saved, the volume of heat dissipater is reduced, energy is saved, at the same time, the line to supply power to that heat dissipation fan is also saved. The said operation control unit 6 changes the electric connection state with the said DCDC converting unit and controller 7 according to the startup operation signal received. Thus, the said controller 7 is in an operation condition only when the system is working and will not lead to the problem of high system energy consumption due to being always in an operation condition.

Next, the system working principle is described through a preferable embodiment of this invention. Specifically, When the system is not started, the said operation control unit 6 and the said controller 7, DCDC converting unit 2 establish no electric connection state between them. When the button of the said remote control 93 or the said ON and OFF button 92 is depressed, the said operation control unit 6 and the said controller 7, DCDC converting unit 2 establish an electric connection between them, the said energy storage device 4 supplies power through the said operation control unit 6 to the said controller 7, the output signal of the said controller 7 drives the said contactor 3 to get connected, the said energy storage device 4 supplies power through the said contactor 3 to the said high-power auxiliary component 80, in the said auxiliary system 8, except the said high-power auxiliary component 80, other devices (for example, hydrogen system, hydrogen safety system) are supplied by the said controller 7, at the same time, the said controller 7 outputs working signals to all modules constituting the said auxiliary system 8 to start the said fuel cell 1; the said fuel cell 1 outputs power to the said DCDC converting unit 2, the said controller 7 controls according to the received state data signals of the said fuel cell 1, energy storage device 4, DCDC converting unit 2 the said DCDC converting unit 2 output current; under the normal system working condition, the output voltage of the said DCDC converting unit 2 is higher than the output voltage of the said energy storage device 4, the output current of the said DCDC converting unit 2 is output through the said power supply output end 5 to the small vehicle drive system carrying the said fuel cell supply system to drive the small vehicle to work, at the same time, the said DCDC converting unit 2 charges the said energy storage device 4, supplies power to the said high-power auxiliary component 80, operation control unit 6; when a small vehicle is in a high-power driving condition, the said power supply output end 5 needs to output high power, high currency, at this time, the said DCDC converting unit 2 output current is not sufficient to satisfy the requirements, the said energy storage device 4 will output current together with the said DCDC converting unit 2 to the small vehicle driving system carrying that fuel cell supply system through the said power supply output end 5 to drive that small vehicle to maintain the high-power driving condition; when the small vehicle is in a braking condition, the power energy recovered by the brake charges through the power supply output end the energy storage device.

When it is necessary to start the system, just depress the button of the said remote control 93 or the said ON and OFF button 92, in the meantime that the said operation control unit 6 and the said controller 7, DCDC converting unit 2 establish an electric connection, the said operation control unit 6 outputs a switch signal to the said controller 7, the said controller 7, after receiving the switch signal, outputs a signal to maintain power supply to the said operation control unit 6, so that the said operation control unit 6 and the said controller 7, DCDC converting unit 2 maintain an electric connection state; at the same time, the said controller 7 also drives the indicator light of the said ON and OFF button 92 to become on to prompt system starting; at this time, the button of the said remote control 93 or the said ON and OFF button 92 can be released.

When it is necessary to close the system, depress again the button of the said remote control 93 or the said ON and OFF button 92, the said operation control unit 6 outputs a switch signal to the said controller 7, the said controller 7, after receiving the switch signal, controls the indicator light of the said ON and OFF button 92 to blink (prompting switching off, at this time, the button of the said remote control 93 or the said ON and OFF button 92 can be released), the said controller 7 simultaneously controls the said auxiliary system 8 to stop working, and then stops outputting the signal to maintain power supply to the said operation control unit 6, so that the electric connection of the said operation control unit 7 and the said controller 7, DCDC converting unit 2 is disconnected; the whole system stops working.

When the said emergency stop button 94 is depressed, the electric connection between the said operation control unit 6 and the said controller 7, DCDC converting unit 2 get disconnected quickly to cut off the power supply to the whole system and make the system stop working.

The said monitoring display 91 gets power, communication data from the said controller 7, displays the system condition, failure information, etc. on the screen.

The embodiment examples of this invention are described above. What needs understanding is that that this invention is not limited to above specific embodiments. The technical people in this field can make various variations or modifications with the Claim, and this does not influence the essential contents of this invention.

1. A miniaturized forklift fuel cell supply system consists of enclosure 90 and the fuel cell system 100 provided in the said enclosure 90, DCDC converting unit 2, contactor 3, energy storage device 4, controller 7, which also consists of the power supply output end 5 provided outside the said enclosure 90 and the operation control unit 6 provided in the said enclosure 90, in which, the said contactor 3 is a normal open type high-current contactor, the said DCDC converting unit 2 includes the DCDC converter 21 and high-power diode 22 connecting with it,
the said fuel cell system 100 connects the said DCDC converting unit 2, contactor 3, power supply output end 5, the said controller 7 connects the said fuel cell system 100, operation control unit 6, contactor 3, the said energy storage device 4 connects the said controller 7, operation control unit 6 and contactor 3,
the said fuel cell system 100, energy storage device 4 are provided in proper order on the electric isolation board 901 of the said enclosure 90 along the said enclosure 90 in a direction from front to back, the said DCDC converting unit 2 is located right above the said energy storage device 4, the said operation control unit 6 and controller 7 are located right above the said DCDC converting unit 2.

2. According to claim 1, the said controller 7 and operation control unit 6 are installed in proper order along the said enclosure 90 in a direction from front to back.

3. According to claim 1, the said contactor 3 is installed in the space between the side board of the said enclosure 90 and the said operation control unit 6.

4. According to claim 1, the hydrogen storage system, the filling valve 95 provided in the said enclosure 90 are also included, the said electric isolation board 901 divides the space of the said enclosure 90 into an electronic system space and a gas supply space, the said fuel cell system 100, DCDC converting unit 2, contactor 3, energy storage device 4, controller 7, operation control unit 6, filling valve 95 are located in the said electronic system space, the said hydrogen storage system is located in the said gas supply space, the said gas supply space is located at the lower part of the said electronic system space.

5. According to claim 1, the output end of the fuel cell 1 that the said fuel cell system 100 contains connects the input end of the said DCDC converting unit 2, the DCDC converting unit 2 connects through the said contactor 3 the said energy storage device 4, the output end of the said DCDC converting unit 2 also connects the said power supply output end 5 and the high-power auxiliary component 80 that the said fuel cell system 100 contains, the port of the said energy storage device 4 connects through the said contactor 3 the said power supply output end 5 and the high-power auxiliary component 80 that the said fuel cell system 100 contains, the said operation control unit 6 connects respectively the said energy storage device 4, DCDC converting unit 2, controller 7, the said controller 7 connects respectively the fuel cell that the said fuel cell system 100 contains, auxiliary system 8, DCDC converting unit 2, the control end of contactor 3, energy storage device 4, in which, the said auxiliary system 8 includes the said high-power auxiliary component 80,
the said operation control unit 6 is used to receive operation signals and supplies power for the said controller 7 and DCDC converting unit 2, the said controller 7 is used to receive the operation instructions generated by the said operation control unit 6 according to the said operation signals and controls according to the said operation instructions the said contactor 3, DCDC converting unit 2, auxiliary system (8), the said controller 7 is also used to measure the state parameters of the fuel cell 1 that the said fuel cell system 100 contains, measure the state parameters of the said energy storage device 4, measures the state parameters of the said auxiliary system and receives the state data of the said DCDC converting unit 2.

6. According to claim 1, the output end of the said fuel cell 1 connects the input end of the said DCDC converter 21, the positive pole of the output end of the said DCDC converter 21 connects the positive pole of the said high-power diode 22, the negative pole of the said high-power diode 22 connects through the said contactor 3 the said energy storage device 4, the said DCDC converter 21 connects the said controller 7 and is controlled by the said controller 7, the said DCDC converter 21 connects the said operation control unit 6 and receives the power supplied by the said operation control unit 6.

7. According to claim 1, the said operation control unit 6 changes the electric connection state with the said DCDC converting unit and controller 7 according to the startup operation signal received.

8. According to claim 1, the state data of the said DCDC converting unit 2 include DCDC input current, DCDC input voltage.

9. According to claim 1, any one or more following devices are also included:
the hydrogen safety system, the said hydrogen safety system includes the sensors placed respectively in the electronic control system space and gas supply space, the said sensors connect the said controller 7;
the monitoring display 91, the said monitoring display 91 connects the said controller 7;
the ON and OFF button 92, the said ON and OFF button 92 connects respectively the said operation control unit 6 and controller 7;
the remote control 93, the said remote control 93 connects in a radio mode the said operation control unit 6; and
the emergency stop button 94, the said emergency stop button 94 connects the said operation control unit 6.
